(19) United States
(12) Patent Application Publication
(10) Pub. No.: US 2010/0096569 A1
(43) Pub. Date: Apr. 22, 2010

(54) ULTRAVIOLET-TRANSMITTING MICROWAVE REFLECTOR COMPRISING A MICROMESH SCREEN

(75) Inventors: Tuan Anh Nguyen, Sunnyvale, CA (US); Yao-Hung Yang, Sunnyvale, CA (US); Sanjeev Baluja, Sunnyvale, CA (US); Thomas Nowak, Cupertino, CA (US); Juan Carlos Rocha-Alvarez, San Carlos, CA (US)

Correspondence Address: Ashok K. Janah, 650 DELANCEY STREET, SUITE 106, SAN FRANCISCO, CA, 94107, US

(73) Assignee: Applied Materials, Inc.

(21) Appl. No.: 12/255,578

(22) Filed: Oct. 21, 2008

(51) Int. Cl. H01J 1/52; C25D 5/02; C25D 1/00

(52) U.S. Cl. 250/505.1; 205/122; 205/71

(57) ABSTRACT

An ultraviolet-transmitting microwave reflector for a substrate processing chamber, comprises a micromesh screen extending across the metallic frame. In one version, the micromesh screen comprises at least one electroformed layer. A method of fabricating the microwave reflector comprises electroforming a metallic frame surrounding a micromesh screen such that the micromesh screen comprises an open area of greater than 80% of the total area.

### BACKGROUND

Embodiments of the present apparatus relate to a microwave reflector used in the ultraviolet treatment of substrates.

In the manufacture of integrated circuits, displays, and solar panels, layers of dielectric, semiconducting, and conducting materials are formed on a substrate such as a semiconductor wafer, glass panel or metal panel. These layers are then processed to form features such as electrical interconnects, dielectric layers, gates and electrodes. In after processes, ultraviolet radiation can be used to treat the layers or features formed on the substrate. Ultraviolet radiation has a wavelength of less than 500 nm, for example, from 10 nm to 500 nm. Ultraviolet radiation can be used in rapid thermal processing (RTP) to rapidly heat a layer formed on the substrate. Ultraviolet radiation is also used to promote curing, or the condensation and polymerization reactions of polymers; generate stressed film layers; and activate gases to clean a chamber.

In one application, ultraviolet (UV) radiation is used to treat films of silicon oxide, silicon carbide, or carbon-doped silicon oxide. For example, commonly assigned U.S. Pat. Nos. 6,566,278 and 6,614,181, both incorporated by reference herein and in their entireties, describe the use of ultraviolet light for the treatment of silicon-oxygen-carbon films. Materials such as silicon oxide (SiOₓ), silicon carbide (SiC), and silicon-oxygen-carbon (SiOCₓ) films are used as dielectric layers in the fabrication of semiconductor devices. Chemical vapor deposition (CVD) methods are often used to deposit these films, and involve promoting a thermal or plasma based reaction between a silicon supplying source and an oxygen supplying source in a CVD chamber. In some processes, water is formed in the deposition of silicon-oxygen-carbon films when an organosilane source which includes at least one Si—C bond is used. This water can be physically absorbed into the films and/or incorporated into the deposited films as Si—OH chemical bonds, both of which are undesirable. UV radiation has been used to treat these CVD films to cure and densifying the deposited film while reducing the overall thermal budget of an individual wafer and speeding up the fabrication process, as for example described U.S. patent application Ser. No. 11/124,908, filed May 9, 2005, entitled “High Efficiency ultraviolet Curing System,” which is assigned to Applied Materials and incorporated by reference herein and in its entirety.

In these and other ultraviolet processes, it is desirable to increase the intensity of the ultraviolet radiation to provide better or faster processes. Microwave generated ultraviolet plasma light sources produce UV radiation efficiently and with good output power. However, the microwave radiation used to generate the UV light should be contained in the ultraviolet generating region. Leakage of microwaves out of this region reduces the amount of microwaves available to generate the ultraviolet light, and can also cause potentially undesirable effects, for example, generate ozone from oxygen in the process zone. The microwaves can also heat up microwave absorbing materials on the substrate or in the chamber sidewalls.

Accordingly, windows have been used to separate the microwave generating region from the process zone, and to contain the microwaves within the ultraviolet source generating region. For example, quartz windows can be used to prevent passage of process gas from the process zone into the microwave generating zone, or vice versa. An electrically conducting wire mesh-like screen between the two regions can also be used to reflect the microwave waves while allowing ultraviolet radiation to pass through the orifices of the mesh.

For various reasons that include these and other deficiencies, and despite the development of various UV treatment techniques, further improvements in ultraviolet treatment technology are continuously being sought.

### SUMMARY

An ultraviolet-transmitting microwave reflector for a substrate processing chamber, comprises a micromesh screen extending across the metallic frame. In one version, the micromesh screen comprising one or more electroformed layers.

A method of fabricating the ultraviolet-transmitting microwave reflector for a substrate processing chamber, comprises electroforming a metallic frame surrounding a micromesh screen such that the micromesh screen comprises an open area of greater than 80% of the total area.

In another version, the ultraviolet-transmitting microwave reflector comprises an ultraviolet transparent plate, and a micromesh screen extending across the ultraviolet transparent plate.

Another method of fabricating an ultraviolet-transmitting microwave reflector comprises forming ultraviolet transparent plate, and electroforming a micromesh screen onto the ultraviolet transparent plate, wherein the micromesh screen comprises an open area of greater than 80% of the total area.

In yet another version, an ultraviolet-transmitting microwave reflector comprises a micromesh screen comprising a grid of solid segments, and a coating media covers the solid segments.

A further method of fabricating an ultraviolet-transmitting microwave reflector comprises electroforming a micromesh screen comprising a grid of solid segments, and coating the solid segments with a coating media.

### DRAWINGS

These features, aspects and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a side schematic cross-sectional view of an embodiment of a substrate processing chamber comprising an ultraviolet-transmitting microwave reflector, ultraviolet lamp, and a microwave source that powers the lamp;

FIG. 2A is a perspective view of an embodiment of an ultraviolet-transmitting microwave reflector;

FIG. 2B is partial perspective view of the microwave reflector of FIG. 1;

FIG. 3A is side cross-sectional view of another embodiment of the microwave reflector having showing solid segments having different cross-sectional areas across the width of the micromesh screen;

FIG. 3B is side cross-sectional view of another embodiment of the microwave reflector showing solid segments having circular cross-sections;

FIG. 3C is a cross-sectional view of an embodiment of a solid segment of a micro mesh screen having a cross-sectional dimension that varies across the length of the solid segment;

FIG. 4 is side cross-sectional view of a microwave reflector having a tapered frame around a micromesh screen;

FIG. 5 is a flowchart of an embodiment of an electroforming process for making a microwave reflector comprising a micromesh screen;

FIG. 6 is a perspective view of another embodiment of a microwave reflector comprising a grid of solid segments supported by an ultraviolet transparent plate;

FIG. 7 is a perspective view of yet another embodiment of a microwave reflector comprising a wire grid embedded in coating media;

FIG. 8 is an embodiment of a frame assembly that can be used to support a microwave reflector having a micro-mesh screen;

FIG. 9 is a top perspective view of an embodiment of an ultraviolet (UV) lamp module comprising a UV lamp module surrounded by a reflector assembly and showing the ultraviolet-transmitting microwave reflector;

FIG. 10 is a schematic top plan view of an embodiment of a substrate processing apparatus comprising a plurality of substrate processing chambers; and

FIG. 11 is a schematic cross-sectional view of a tandem version of an embodiment of a substrate processing chamber.

### DESCRIPTION

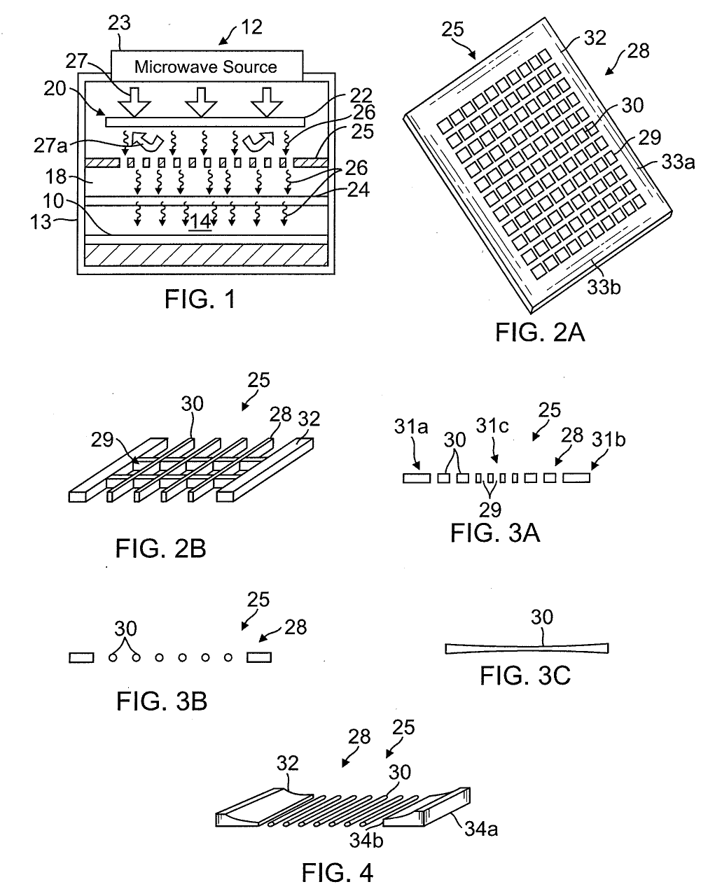

Ultraviolet (UV) treatment can be used to treat layers and materials on a substrate 10, such as semiconducting wafer, display, or solar panel, in a substrate processing chamber 12, as schematically illustrated in FIG. 1. The substrate processing chamber 12 can be an ultraviolet treatment chamber, a combined CVD or PVD and ultraviolet treatment chamber, or any other chamber that performs a combination of processing tasks. The chamber 12 comprises walls 13 enclosing a process zone 14 which holds a substrate support 16 for supporting the substrate 10. The ultraviolet radiation can be generated in an ultraviolet generation zone 18 above the substrate 10.

An ultraviolet lamp module 20 is used to generate the ultraviolet radiation in the ultraviolet generation zone 18. The lamp module 20 comprises a UV lamp 22 that emits ultraviolet radiation. The UV lamp 22 can be any UV source such as mercury microwave arc lamp, pulsed xenon flash lamp or high-efficiency UV light emitting diode array. In one version, the UV lamp 22 comprises a sealed plasma bulb filled with one or more gases such as xenon (Xe) or mercury (Hg) for excitation by a power source 23, such as a microwave source, which generates the microwaves 25. In another embodiment, the UV lamp 22 includes a filament which is powered by a power source 23 (shown schematically) that supplies direct current to the filament. The UV lamp 22 can also be powered by a power source 23 comprising a radio frequency (RF) energy source that can excite the gas within the UV lamp 22. The UV lamp 22 is shown as an elongated cylindrical bulb for illustrative purposes; however, UV lamps having other shapes can also be used, such as spherical lamps or arrays of lamps, as would be apparent to one of ordinary skill in the art. A suitable UV lamp 22 is commercially available from, for example, Nordson Corporation in Westlake, Ohio; or from Miltec UV Company in Stevenson, Md. In one embodiment, the UV lamp 22 includes a single elongated UV H+ bulb from Miltec UV Company. In other embodiments, the UV lamp 22 may include two or more spaced apart elongated bulbs.

An UV transparent plate 24 isolates the UV lamp module 20 and separates the UV generation zone 18 from the underlying process zone 14. The plate 24 also eliminates particulate contamination from the substrate 10 to the UV lamp 22, and permits the use of gases to cool the UV lamp 22 and/or microwave source. The plate 24 also allows process gases to be used in the process zone 14 without these gases interfering with the operation of the UV lamp 22. In one embodiment, the plate 24 is fabricated from a quartz material having an optical transmittance substantially transparent to the desired UV wavelengths. An example of such a quartz material is commercially available under the trade name Dynasil 1000 from the Dynasil Corporation in West Berlin, N.J. Other materials can be used to generate ultraviolet radiation having different wavelengths, such as wavelengths below 220 nm. The plate 24 can also be coated with an anti-reflection coating to minimize back reflections of UV radiation into the UV generation zone 18. For example, the plate 24 may be coated with magnesium fluoride, silicon, fluorine, and other coatings.

An ultraviolet-transmitting microwave reflector 25 is placed in front of the UV lamp module 20 to allow ultraviolet (UV) radiation 26 to be transmitted through the microwave reflector 25, while simultaneously reflecting back microwaves 27 generated above the UV lamp 22, the reflected microwave being illustrated by the arrows 27a. The microwave reflector 25 is useful for reflecting the microwaves 27a back into the ultraviolet generating zone 18. At the same time, the ultraviolet radiation 26 generated in the UV generating zone 28 is transmitted through the microwave reflector 25 to treat a substrate 10 located in the process zone 14 of the chamber 12.

In one embodiment, the microwave reflector 25 comprises a micromesh screen 28 that provides a large open area that allows a large percentage of the ultraviolet radiation generated by the UV lamp 22 to pass through the screen 28, as shown in FIGS. 2A and 2B. The larger the size of the openings 29 in the micromesh screen 28, the lower is the attenuation of the ultraviolet radiation 26 that is reflected by the solid areas between the openings 29. Thus the micromesh screen 28 comprises an open area of greater than 80% of the total area of the screen, which is the area covered by the grid of solid segments 30. However, the micromesh screen 28 can even have openings 29 sized to provide an open area of greater than 95% of the total area. In the example illustrated, the micromesh screen 28 comprises openings 29 that are rectangular. However, the openings 29 can be of other shapes as would be understood by one of ordinary skill in the art of grid manufacture.

In this version, the openings 29 of the micromesh screen 28 are also sized to cause microwaves to “bounce off” the screen 28 while still maximizing the amount of ultraviolet radiation 26 that passes through the micromesh screen 28, as shown in FIG. 1. The openings 29 are sized to cause the microwaves 27 (or other radiation used to energize the UV lamp 22) to “bounce off” the micromesh screen 28 as shown by the arrows 27a in FIG. 1. A suitable opening to reflect microwaves has a dimension in any direction that is at least about ¼ of the wavelength of the microwaves. For microwave radiation having a frequency of 2 GHz (150 mm wavelength), the micromesh screen 28 comprises openings 29 that are approximately sized to 25 mm². It should be understood that if the screen is used to reflect other types of radiation, or microwave radiation having a different wavelength, the openings 29 are sized accordingly as would be apparent one of ordinary skill in the art.

In one version, the micromesh screen 28 comprises a grid of solid segments 30 that define the openings 29. In the version shown in FIGS. 2A and 2B, the solid segments 30 are substantially uniformly in thickness and define openings 29 having the same size, however, the thickness of the solid segments 30 can also vary across the grid or across the length of a grid opening. In one version, a continuous layer of solid segments 30 intersect one another to form the micromesh screen 28, for example, when the screen 28 is made by a deposition process such as electroforming, PVD or CVD. In the deposition version, the screen 28 is essentially a continuous layer of solid material with a pattern of openings 29 created by an intersecting pattern of linear or non-linear solid segments 30. However, the screen 28 can also be made from individual wires, or pattern of solid portions which are joined together at the intersections to define the openings 29 between the solid segments 30. While an exemplary version of the openings 29 is shown to have a rectangular shape, should be understood that the openings 29 can have other shapes, such as arcuate shapes, for example circular or elliptical shapes.

The dimensions or width of the solid segments 30 between the openings 29 affects the strength of the micromesh screen 28. If the solid material between openings 29 has too small or too fine a dimension, the micromesh screen 28 can be difficult to handle, and can break when installed or removed from the UV lamp module 20 for cleaning. Thus, the size of the solid segments 30 can limit the size of the openings 29 between the solid segments 30. In one version, a micromesh screen 28 having a good mechanical strength is formed by patterning the solid segments 30 between the openings 29 such that each opening has an open area of less than 5 mm².

In the version shown in FIGS. 2A and 2B, the micromesh screen 28 comprises a grid of solid segments 30 that each have a rectangular cross-section with a height and width. The rectangular solid segments 30 provide control over the spatial orientation of the dimensions of the solid segments 30. For example, a micromesh screen 28 having a high lateral strength can be made from solid segments 30 having a taller height than width. The taller height provides a greater thickness in the vertical direction while minimizing the thickness in the horizontal direction to provide improved mechanical strength for the micromesh screen 28 while allowing a higher quantity of UV radiation to pass through the openings 29. The smaller width of the solid segments 30 provides more open area facing the ultraviolet lamp to allow a greater percentage of the radiation of the lamp to pass through the screen. In one version, the solid segments 30 comprise a ratio of height to width of at least about 1.5, or even from about 2 to about 5. For example, the segments 30 can have a width of from about 10 to about 100 microns, and a height of from about 2 to about 500 microns.

In another version, the solid segments 30 comprise rectangles of different dimensions, as illustrated in FIG. 3A. For example, the solid segments 30 can have a larger first cross-sectional area at the peripheral regions 31a,b of the micromesh screen 28, and a smaller second cross-sectional area at the central region 31c of the micro-screen. This version minimizes the dimension of the solid segments 30 in the center of the UV lamp 22 while still retaining sufficient strength at the peripheral edges of the screen 28. Conversely, and depending on the spectral intensity profile of the ultraviolet radiation output of a particular UV lamp 22 or UV lamp module 20, the cross-sectional profile of the solid segments 30 can be otherwise selected to balance and even out the ultraviolet intensity radiation profile across the lamp module 20. In one example, the solid segments 30 at the peripheral regions 31a,b can have a first diameter or width that is from about 0.01 mm to about 0.5 mm, and the solid segments 30 of at the central region 31c can have a second diameter that is from about 0.002 mm to about 0.1 mm. The dimension of the solid segments 30 can decrease from the peripheral regions 31a,b to the central region 31c, or vice versa, in a stepwise fashion or in a continuous fashion.

In still another version, the solid segments 30 of the micromesh screen 28 have a circular cross-section, as shown in FIG. 3B. By circular cross-section it is meant a circle, elliptical or oval shape. The circular cross-section sectional profile provides greater compressive strength and is desirable when compressive stresses are applied to the microwave reflector 25 and micromesh screen 28 during assembly or use. In one version, the solid segments 30 having a circular cross-sectional profile have a diameter of from about 10 to about 100 microns. The solid segments 30 having a circular cross-section can also be extruded wires that are laid out to overlap one another in the desired pattern, and joined at their overlapping joints with an adhesive (not shown). For example, an adhesive can be sprayed over the solid segments 30 to lock the joints in place to form the grid.

The solid segments 30 can also have a dimension that changes across their lengths, as shown in FIG. 3C. In this version, a cross-sectional dimension, such as with a diameter or width changes across the length of the solid segment 30. For example, the cross-sectional dimension can gradually decrease towards the center of the micromesh screen 28. In this version, the cross-sectional dimension of the solid segment 30 comprises a first larger dimension at its peripheral edges, and a second smaller dimension at its central region, or vice versa. For example, the cross-sectional dimension can gradually taper from a first dimension of at least about 100 microns to a second dimension of less than about 20 microns.

The micromesh screen 28 can be made from any suitable microwave reflecting material that can be fabricated in the desired structure, by processes such as electroplating/electroforming, casting, injection molding, or other fabricating techniques. In one version, the micromesh screen 28 is made from a conducting metal. Metals having a high atomic number of at least about 13 or higher are better, because are more stable. The metal material can also have a high density, such as at least about 19 g/cm³ or higher. For instance, the micromesh screen 28 can be made from a metal such as nickel, nickel-iron, copper, silver, gold, lead, tungsten, uranium or alloys thereof.

In the embodiment shown in FIGS. 2A and 2B, the microwave reflector 25 also comprises a metallic frame 32 that surrounds the micromesh screen 28. The metallic frame 32 is provided to strengthen the fragile micromesh screen 28, for example, when the micromesh screen 28 has fine cross-sectional dimensions. This version is particularly useful when the micromesh screen 28 comprises solid segments 30 which are sized in the micron range. However, the metallic frame 32 can also be used when the solid segments 30 are spaced apart by openings 29 having large dimensions, and consequently, provide a screen having low mechanical strength or rigidity. These versions can often break or bend during their installation into the ultraviolet treatment chamber 12.

The metallic frame 32 surrounds the micromesh screen 28 so that the screen 28 stretches to extend across the metallic frame 32. In the version shown, the metallic frame 32 comprises longitudinal and lateral borders 33a,b, respectively, that each have a rectangular cross-sectional profile. The cross-sectional dimensions the longitudinal and lateral borders 33a,b can be the same, or the longitudinal border 33a can have a first rectangular cross-section that is sized differently than a second rectangular cross-section of the lateral border 33b. In one version, the longitudinal and lateral borders 33a,b of the metallic frame 32 comprise a width of at least about 20 mm, and a thickness of from about 10 microns to about 100 microns, or even from about 30 microns to about 80 microns.

In another version, the metallic frame 32 comprises a tapered cross-section, as shown in FIG. 4. In this version, the metallic frame 32 has a longitudinal border 33a with an outer perimeter 34a having a first thickness, and an inner perimeter 34b having a second thickness that is lower than the first thickness. This provides structural rigidity to the metallic frame 32 while reducing the amount of material used to make the frame. Such a frame cross-section a suitable when the material used to make the frame is expensive, or the process for building a thickness of the frame is time-consuming. The metal chosen for the metallic frame 32 can be the same material as that chosen for the micromesh screen 28 or a different material, and can be an elemental metal or metal alloy.

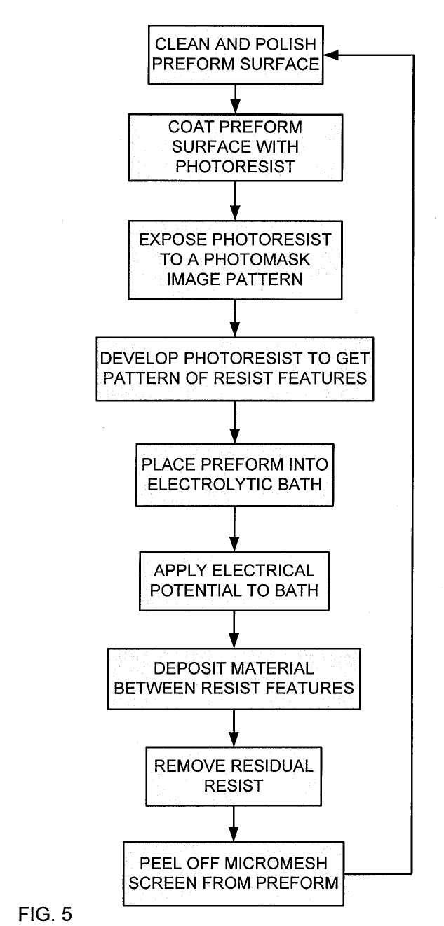

In one embodiment, the micromesh screen 28 is made by an electroforming process, as illustrated in FIG. 5, and comprises one or more electroformed layers. In this method, a smooth preform of metal, plastic, ceramic or glass is cleaned. A suitable material for the preform is for example, copper, nickel or stainless steel. The preform is polished to provide a smooth polished surface to allow the electroformed mesh to easily be stripped off. A layer of a conducting material can also be applied over the preform when the preform is non-conducting, such as a glass preform; or to provide a base layer below the deposited material. The surface of the preform is coated with a layer of light sensitive photoresist in a sheet form can also be laminated to the polished conductive surface of the preform. A photomask of a micromesh pattern having the pattern for the desired micromesh screen is placed over the photoresist and a light source is used to imprint an image of the micromesh pattern on the photoresist. The exposed photoresist is then rinsed in various developer solutions which cure, dissolve and/or remove the unexposed or exposed portions of the photoresist. As a result, a pattern of raised resist features corresponding to the filled-in openings of the micromesh screen are created on the preform (not shown).

Conducting material from an electrolytic solution is then deposited on the recessed regions between the patterned resist features to form the interconnected solid segments 30 that define the micromesh screen 28. In this process, the backside of the preform is covered with a nonconductive material to prevent deposition of metal on this side. The preform is then immersed in a metal-containing electroforming solution, containing a nickel or copper salt, such as for example, nickel sulfamate or copper sulfate. An electrical current is passed through the solution, using the conductive preform surface as the cathode and an electrode of the metal to be deposited as the anode. Preferred anode materials comprise nickel or copper. When an electrical potential is across the solution, metal is deposited on the conductive exposed mandrel surface in the pattern defined by the nonconductive resist features. The electroforming process is continued until the desired thickness is obtained for the solid segments 30 of the micromesh screen 28. After electroforming the micromesh screen 28 is stripped off the preform. In applications where the micromesh has very fine lines, residual photoresist can be first removed by washing in a dissolving solution before lifting the electroformed micromesh screen 28 off the preform.

In one version, the metallic frame 32 can also be made as an integral and unitary structure with the micromesh screen 28. It was determined that an electroforming process can be used to form both the metallic frame 32 and the micromesh screen 28 at the same time by incorporating the pattern of the metallic frame 32 with the pattern of the openings 30 of the micromesh screen 28 into a single patterned photomask. The electroforming process creates a metallic frame 32 and micromesh screen 28 that are a continuous electroformed layer.

Advantageously, the electroforming process allows high-quality, fine patterns for the micromesh screen 28. A microwave reflector 25 made by an electroforming process provides greater than 98% reflectance of microwave radiation having a frequency of greater than 20 GHz and a UV transmittance of greater than 80%. The process also permits quality production at relatively low unit costs with good process repeatability and control. Electroforming also generates a micromesh screen 28 of solid segments 30 comprising very fine lines, and can be used to form solid segments 30 in arcuate sections, or other patterns. The precision and resolution obtained in the photographically reproduced pattern, allows the micromesh screen to have fine line geometries and tighter tolerances. However, the exemplary method of electroforming fabrication is provided to illustrate a fabrication method, and other methods can be used to form the microwave reflector 25 and micromesh screen 28. Also, different electroforming materials and solutions can be employed as would be apparent to those of ordinary skill in the art.

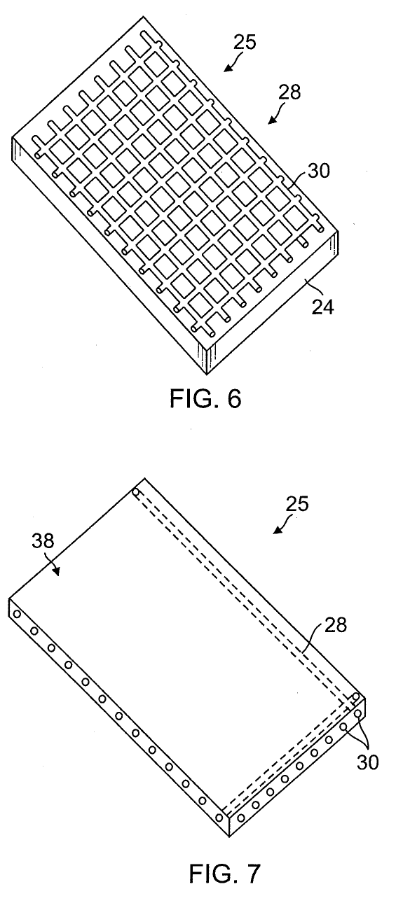

Another embodiment of the ultraviolet-transmitting microwave reflector 25 comprises a micromesh screen 28 extending across, and supported by, a UV transparent plate 24, as shown in FIG. 6. A suitable ultraviolet transparent material comprises an ultraviolet transmission of at least about 80% of the ultraviolet radiation incident on the material. For example, an ultraviolet-transmitting material that can be used to form the UV transparent plate 24 includes silicon dioxide, for example quartz. A suitable quartz plate can have a thickness of from about ¼″ to about 2″. In the chamber 12, the UV transparent plate 24 comprising a superimposed micromesh screen 28 can also be used to replace the previously described UV transparent plate 24 by itself. The micromesh screen 28 can be electroformed as a separate structure and then adhered or otherwise joined to an UV transparent plate 24. In another version, the micromesh screen 28 is electroformed directly onto an UV transparent plate 24. In the latter, a quartz plate is formed by casting a quartz slab and machining the slab to form a plate having the desired shape and dimensions. The flat surfaces of the slab can be polished using conventional polishing methods to form smooth surfaces. Thereafter, a conductive grid pattern corresponding to the micromesh screen 28 is formed on the quartz plate using photoresist methods as described above. The resultant structure is immersed in an electroforming solution to electroform a micromesh screen 28 directly onto the UV transparent plate 24.

In yet another version, a micromesh screen 28 comprising a grid of solid segments 30 is coated with a coating media 38 so that the coating media covers the solid segments 30, as shown in FIG. 7. The coating media 38 can also be an ultraviolet-transmitting media. In one version, the coating media comprises a thickness of from about 2 microns to about 10 microns. In this method, a micromesh screen 28 comprising a grid of solid segments 30 is formed by electroforming. Thereafter, the solid segments 30 are coated with a coating media 38. For example, a coating media 38 comprising polymer can be spread over the solid segments 30. In one version, the polymer is provided as a liquid, and applied over the grid of solid segments 30. The polymer is then cured by heating or other treatment to form a wire mesh embedded in a polymer structure.

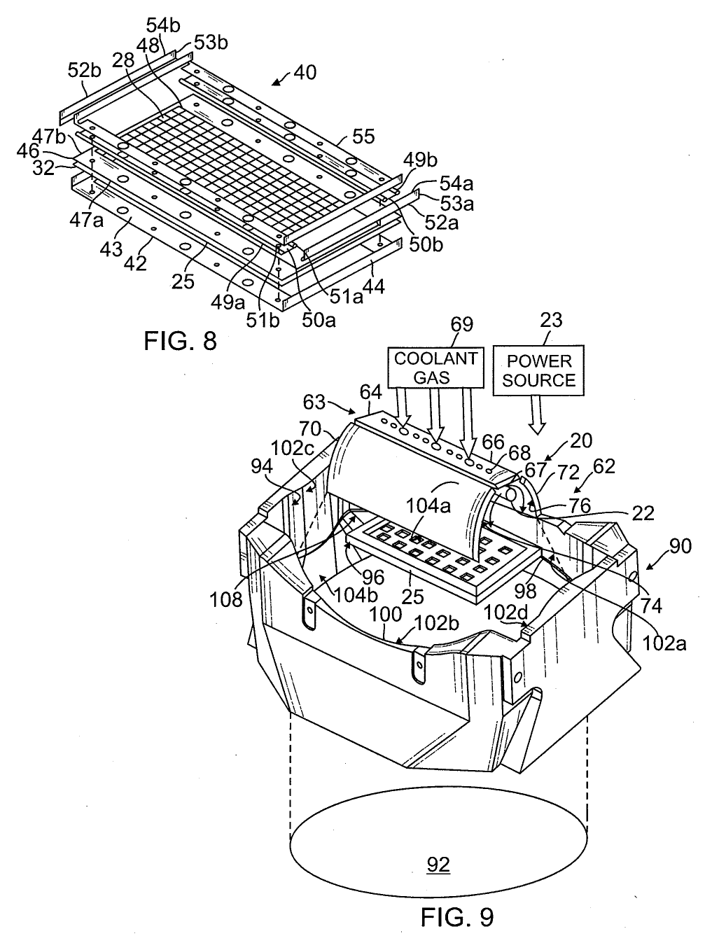

An embodiment of a frame assembly 40 that can be used to support the framed micromesh screen 28 in front of a UV lamp 22 is shown in FIG. 8. In this version, the frame assembly 40 comprises an outer frame 42 comprising a border 43 that fits the metallic frame 32 of the microwave reflector 25 and upwardly extending flanges 44 that extend upward from the top and bottom sections of the border 43. The metallic frame 32 of the microwave reflector 25 is positioned over and covering the border 43 of the outer frame 42. A frame mount 46 comprising longitudinal and lateral edges 47a,b that surround a rectangular cutout 48, is fitted over the metallic frame 32 of the microwave reflector 25 to hold the frame to relieve stresses on the micromesh screen 28. The outer frame 42 and the frame mount 46 sandwich the frame 32 of the microwave reflector 25 therebetween to provide mechanical strength and rigidity to the fine micro-mesh screen 28. A pair of side gaskets 49a,b each comprises a longitudinal strip 50a,b with posts 51a,b on their inner and outer edges is positioned over the longitudinal edges 47a of the frame mount 46. A pair of top and bottom gaskets 52a,b, each comprise a longitudinal strip 53a,b with vertically extending outer flanges 54a,b. A frame trap 55 is mounted over the gaskets 49a,b and 52a,b to retain and trap the entire frame assembly 40. In this version, the microwave reflector 25 has a rectangular shape, consequently, the various components of the frame assembly 40 are also shaped to have cutouts that match the rectangular shape of the micro-mesh of the microwave reflector 25, other frame shapes and configurations can also be used.

A UV lamp module 20 that includes a UV lamp 22, the microwave reflector 25, and a reflector assembly 62 that includes a primary reflector 63 that partially surrounds the UV lamp 22, is shown in FIG. 9. The primary reflector 63 comprises a set of reflectors that may include a central reflector 64 that is centrally positioned behind, and in a spaced relationship with respect to, the UV lamp 22. The central reflector 64 comprises a longitudinal strip 66 having a curved reflective surface 67 that faces the back of the UV lamp 22 to reflect backward directed rays of ultraviolet radiation emitted by the UV lamp 22 towards the substrate 10. A plurality of through holes 68 are provided in the longitudinal strip 66 to allow a coolant gas 69 to be directed from an external coolant gas source toward the UV lamp 22. The primary reflector 63 can also include first and second side reflectors 70, 72, which are positioned on either side of the central reflector 64. The primary reflector 63, as well as the first and second side reflectors 70, 72 can also be made of cast quartz, and have an interior surface that is an arcuate reflective surface 74, 76, respectively. Any of the central and side reflectors 64, 70, 72, respectively, may be elliptical or parabolic reflectors, or include a combination of both elliptical and parabolic reflective portions. Optionally, an dichroic coating (not shown) can be applied to any of the reflective surfaces of the central reflector 64, or side reflectors 70, 72, the dichroic coating 36 being a thin-film filter that selectively passes through light having a small range of wavelengths while reflecting other wavelengths.

The reflector assembly 62, can also include a secondary reflector 90 in addition to the primary reflector 63, as shown in FIG. 9. The secondary reflector 90 further channels and redirects UV radiation that would otherwise fall outside the boundary of the primary reflector's flood pattern so that this reflected radiation impinges upon the substrate 10 being treated to increase the intensity of the energy radiating the substrate 10. The secondary reflector 90 alters the flood pattern of UV lamp 22 from a substantially rectangular area to a substantially circular shape 92 that corresponds to the substantially circular semiconductor substrate 10 being exposed. The secondary reflector 90 includes an upper portion 94 and a lower portion 96 which meet at a vertex 98 that extends around the interior perimeter of the reflector 90. Upper portion 94 includes a semicircular cut-out 100 to allow unobstructed flow of cooling air to the UV lamp 22. The upper portion 94 also includes two opposing and generally inward sloping (from the top) longitudinal surfaces 102a,b and two opposing transverse surfaces 102c,d. Transverse surfaces 102b are generally vertical and have a convex surface along the transverse direction. Longitudinal surfaces 102a are generally concave along the longitudinal direction. Lower portion 96, which is positioned directly below upper portion 94, includes two opposing and generally outward sloping (from the top) surfaces 104a and two opposing generally outward sloping transverse surfaces 104b. In the embodiment shown, the surfaces 10b are at a reduced angle (relative to the vertical) than surfaces 102a. The longitudinal surfaces 102a are generally concave along the longitudinal direction while surfaces 102b are generally convex (with a notable exception being in corners 108 where the lower portion of surface 102a meets the lower portion of surface 102b) along the transverse direction.

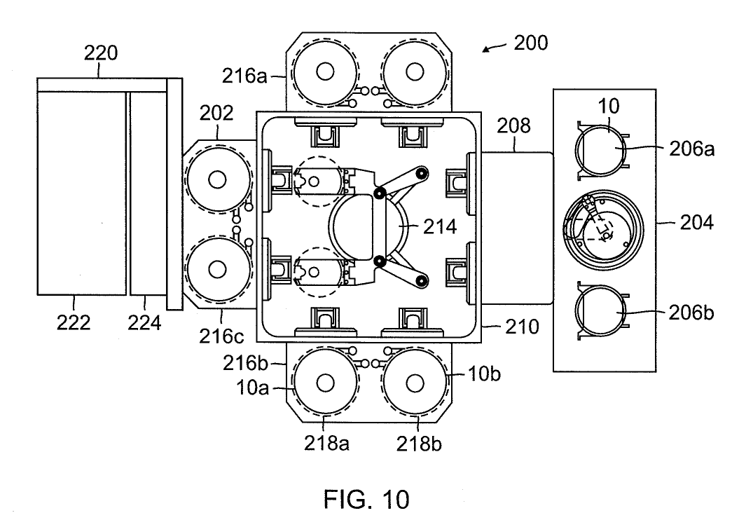

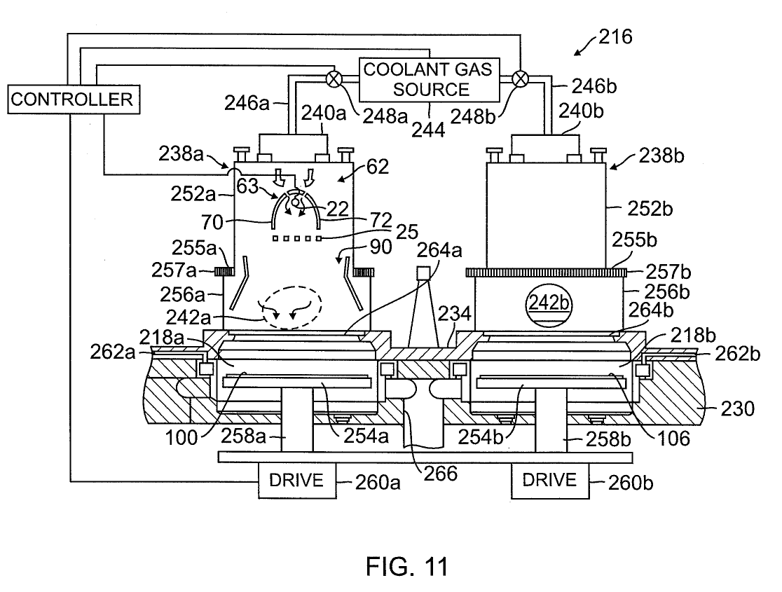

The ultraviolet lamp module 20 as described herein, can be used in many different types of a substrate processing apparatus, including for example, semiconductor processing apparatus, solar panel processing apparatus, and display processing apparatus. An exemplary substrate processing apparatus 200 which can be used to process semiconductor wafers, such as silicon or compound semiconductor wafers, is shown in FIGS. 10 and 11. The apparatus 200 illustrates one embodiment of a Producer™ processing system, commercially available from Applied Materials, Inc., of Santa Clara, Calif. The apparatus 200 is a self-contained system having the necessary processing utilities supported on a mainframe structure 202, as shown in FIG. 5. The apparatus 200 generally includes a cassette loading chamber 204 where substrate cassettes 206a,b are supported to allow loading and unloading of substrates 10 into and from a loadlock chamber 208, a transfer chamber 210 housing a substrate handler 214, a series of tandem process chambers 216a-c are mounted on the transfer chamber 210. A utility end 220 houses the support utilities needed for operation of the apparatus 200, such as a gas panel 222, and a power distribution panel 224.

Each of the tandem process chambers 216a-c include a process zones 218a,b (as shown for chamber 216b) capable of processing a substrates 10a,b, respectively. The two process zones 218a,b share a common supply of gases, common pressure control and common process gas exhaust/pumping system, allowing rapid conversion between different configurations. The arrangement and combination of chambers 216a-c may be altered for purposes of performing specific process steps. Any of the tandem process chambers 216a-c can include a lid as described below that includes one or more UV lamps 22 for use to treat material on a substrate 10 and/or for a chamber clean process. In the embodiment shown, all three of the tandem process chambers 216a-c have UV lamps 22 and are configured as UV curing chambers to run in parallel for maximum throughput. However, in alternative embodiments, all of the tandem process chambers 216a-c may not be configured as UV treatment chambers, and the apparatus 200 can be adapted to have chambers that perform other processes such as chemical vapor deposition (CVD), physical vapor deposition (PVD), etch, or combinations of these processes and UV treatment performed in the same chamber. For example, the apparatus 200 can be configured with one of the tandem process chambers 216a-c as a CVD chamber for depositing materials, such as a low dielectric constant (K) film, on a substrate 10.

An embodiment of a tandem process chamber 216 of the apparatus 200 that is configured for UV treatment of substrates 10 such as semiconducting wafers, is shown in FIG. 6. The process chamber 216 includes a body 230 and a lid 234 that can be hinged to the body 230. Coupled to the lid 234 are two housings 238a,b that are each coupled to inlets 240a,b along with outlets 242a,b for passing a coolant gas through an interior of the housings 238a,b. The coolant gas is obtained from a coolant gas source 244, via the pipes 246a,b, and flow controllers 248a,b, and the coolant gas can be at room temperature or lower, such as approximately 22° C. The coolant gas source 244 provides coolant gas at a sufficient pressure and flow rate to the inlets 240a,b to insure proper operation of the UV lamps 22 and/or power sources for the lamps associated with the tandem process chamber 216a-c. Details of a cooling module that can be used in conjunction with tandem process chamber 216 can be found in commonly assigned U.S. application Ser. No. 11/556,642, entitled “Nitrogen Enriched Cooling Air Module for UV Curing System,” filed on Nov. 3, 2006, which is incorporated by reference herein and in its entirety. The formation of ozone can be avoided by cooling the lamps with oxygen-free coolant gas (e.g., nitrogen, argon or helium). In one version, the coolant gas source 244 provides a coolant gas comprising nitrogen at a flow rate of from about 200 to 2000 sccm. The outlets 242a,b receive the exhausted coolant gas from the housings 238a,b, which is collected by a common exhaust system (not shown) that can include a scrubber to remove ozone potentially generated by the UV bulbs depending on bulb selection.

Each of the housings 204 cover one of two UV lamps 22 disposed respectively above two process zones 218a,b defined within the body 230. While a single UV lamp 22 a shown above each process zones 218a,ba,b, it should be noted that multiple UV lamps can be used to increase the total irradiation, as for example described in US patent publication no. 20070257205A1, entitled, “APPARATUS AND METHOD FOR TREATING A SUBSTRATE 10 WITH UV RADIATION USING PRIMARY AND SECONDARY REFLECTORS,” filed on Mar. 15, 2007, which is incorporated by reference herein in its entirety. Each of the housings 238a,b comprises an upper housing 252a,b in which the UV lamp 22 is positioned, and a lower housing 256a,b in which the secondary reflector 90 is placed. In the version shown, a disc 255a,b having a plurality of teeth 257a,b, respectively, that grip a corresponding belt (not shown) that couples the disc to a spindle (not shown) which in turn is operatively coupled to a motor (not shown). The discs 255a,b, belts, spindle, and motor allow the upper housings 252a,b (and the UV lamps 22 mounted therein) to be rotated relative to a substrate positioned on a the substrate support 254a,b. Each secondary reflector 90 is attached to the bottom of respective disc 255a,b by a bracket (not shown) which allows the secondary reflectors to rotate within the lower housings 256a,b along with the upper housings 252a,b and UV lamps 22. Rotating the UV lamp 22 relative to the substrate 10a,b being exposed improves the uniformity of exposure across the surface of the substrate. In one embodiment, the UV lamps 22 can be rotated at least 180 degrees relative to the substrate 10a,b being exposed, and in other embodiments the UV lamps 22 can be rotated 270 degrees or even a full 360 degrees.

Each of the process zones 218a,b includes a substrate support 254a,b for supporting a substrate 10a,b within the process zones 218a,b. The supports 254a,b can be heated, and can be made from ceramic or metal such as aluminum. Preferably, the supports 254a,b couple to stems 258a,b that extend through a bottom of the body 230 and are operated by drive systems 260a,b to move the supports 254a,b in the processing zones 250a,b toward and away from the UV lamps 22. The drive systems 260a,b can also rotate and/or translate the supports 254a,b during curing to further enhance uniformity of substrate illumination. Adjustable positioning of the supports 254a,b also enables control of volatile cure by-product and purge and clean gas flow patterns and residence times in addition to potential fine tuning of incident UV irradiance levels on the substrates 10a,b depending on the nature of the light delivery system design considerations such as focal length.

In the version shown, the UV lamp 22 is an elongated cylindrical sealed plasma bulb filled with mercury for excitation by a power source (not shown) comprising a microwave source that supplies microwaves to the UV lamp 22. In one version, the microwave source includes a magnetron and a transformer to energize filaments of the magnetrons. In one version, a kilowatt microwave power source generates microwaves is adjacent to an aperture (not shown) in the housings 238a,b and transmits microwaves through the aperture to the UV lamp 22. A microwave source that provides up to 6000 Watts of microwave power can generate up to about 100 W of UV light from each of the UV lamps 22. In one version, the UV lamp 22 emits UV light across a broad band of wavelengths from 170 nm to 400 nm. The gases in the UV lamp 22 determines the wavelengths emitted, and since shorter wavelengths tend to generate ozone when oxygen is present, UV light emitted by the UV lamps 22 can be tuned to predominantly generate broadband UV light above 200 nm to avoid ozone generation during UV treatment processes.

The UV light emitted from each UV lamp 22 enters one of the processing zones 250a,b by passing through windows 264a,b disposed in apertures in the lid 234. In one version, the windows 264a,b comprise an ultraviolet transparent plate, such as a plate of synthetic quartz glass, and have a sufficient thickness to maintain vacuum without cracking. For example, the windows 264a,b can be made from OH free fused silica that transmits UV light down to approximately 150 nm. The lid 234 seals to the body 230 so that the windows 264a,b are sealed to the lid 234 to provide process zones 218a, having volumes capable of maintaining pressures from approximately 1 Torr to approximately 650 Torr. Process gases enter the process zones 218a,b via one of two inlet passages 262a,b and exit the process zones 218a,b via the common exhaust port 266. Also, the coolant gas supplied to the interior of the housings 238a,b circulates past the UV lamps 22, but is isolated from the process zones 218a,b by the windows 264a,b.

An exemplary ultraviolet treatment process, in which a low-k dielectric material comprising silicon-oxygen-carbon is cured, will now be described. For such curing processes, the supports 254a,b are heated to between 350° C. and 500° C., and the process zones 258a,b are maintained at a gas pressure of from about 1 to about 10 Torr to enhance heat transfer to the substrate 10 from the supports 254a,b. In the curing process, helium is introduced at a flow rate of 14 slm at a pressure of 8 Torr in each of the tandem chambers 216a-c (7 slm per side of the twin) via each of the inlet passages 262a,b. For some embodiments, the cure processes can also use nitrogen (N₂) or argon (Ar) instead or as mixtures with He. The purge gas remove curing byproducts, promote uniform heat transfer across the substrates 10a,b, and minimize residue build up on the surfaces within the processing zones 250a,b. Hydrogen can also be added to remove some methyl groups from films on the substrates 10 and to scavenge oxygen released during curing.

In another embodiment, the curing process uses a pulsed UV lamp 22 which can use pulsed xenon flash lamp. The process zones 218a,b are maintained under vacuum at pressures of from about 10 mTorr to about 700 Torr, while the substrates 10a,b are exposed to pulses of UV light from the UV lamps 22. The pulsed UV lamps 22 can provide a tuned output frequency of the UV light for various applications.

A clean process can also be performed in the process zones 218a,b. In this process, the temperature of the supports 254a,b can be raised to between about 100° C. to about 600° C. In the clean process, elemental oxygen reacts with hydrocarbons and carbon species that are present on the surfaces of the processing zones 250a,b to form carbon monoxide and carbon dioxide that can be pumped out or exhausted through the exhaust port 266. A cleaning gas such as oxygen can be exposed to UV radiation at selected wavelengths to generate ozone in-situ. The power sources can be turned on to provide UV light emission from the UV lamps 22 in the desired wavelengths, preferably about 184.9 nm and about 253.7 nm when the cleaning gas is oxygen. These UV radiation wavelengths enhance cleaning with oxygen because oxygen absorbs the 184.9 nm wavelength and generates ozone and elemental oxygen, and the 253.7 nm wavelength is absorbed by the ozone, which devolves into both oxygen gas as well as elemental oxygen. In one version of a clean process, process gas comprising 5 slm of ozone and oxygen (13 wt % ozone in oxygen) was flowed into the tandem chambers 216a,b, split evenly within each process zone 218a,b to generate sufficient oxygen radicals to clean deposits from surfaces within the process zones 218a,b. The O₃ molecules can also attack various organic residues. The remaining O₂ molecules do not remove the hydrocarbon deposits on the surfaces within the processing zones 250a,b. A sufficient cleaning process can be performed with a twenty minute clean process at 8 Torr after curing six pairs of substrates 10a,b.

Although exemplary embodiments of the present invention are shown and described, those of ordinary skill in the art may devise other embodiments which incorporate the present invention, and which are also within the scope of the present invention. Furthermore, the terms below, above, bottom, top, up, down, first and second and other relative or positional terms are shown with respect to the exemplary embodiments in the figures are interchangeable. Therefore, the appended claims should not be limited to the descriptions of the preferred versions, materials, or spatial arrangements described herein to illustrate the invention.

What is claimed is:

1. An ultraviolet-transmitting microwave reflector for a substrate processing chamber, the reflector comprising:
(a) a metallic frame;
(b) a micromesh screen extending across the metallic frame, the micromesh screen comprising one or more electroformed layers.

2. A reflector according to claim 1 wherein the micromesh screen comprises an open area of greater than 80% of the total area.

3. A reflector according to claim 1 wherein the metallic frame and micromesh screen comprise at least one electroformed layer.

4. A reflector according to claim 1 wherein the metallic frame comprises at least one of the following characteristics:
(i) a width of at least about 20 mm; or
(ii) a thickness of from about 20 microns to about 100 microns.

5. A reflector according to claim 1 wherein the micromesh screen comprises a plurality of openings having at least one of the following characteristics:
(i) each opening has an area of least 1 mm²; and
(ii) each opening has an area of less than 10 mm².

6. A reflector according to claim 1 wherein the micromesh screen comprises a grid of solid segments having at least one of the following characteristics:
(i) a rectangular cross-section; and
(ii) a ratio of height to width of at least about 1.5; and
(iii) a ratio of the height to width is from about 2 to about 5.

7. A reflector according to claim 6 wherein the solid segments comprise a width of from about 10 to about 100 microns and a height of from 2 to about 500 microns.

8. A reflector according to claim 1 wherein the solid segments comprise a circular cross-section having a diameter of from about 10 to about 100 microns.

9. A method of fabricating an ultraviolet-transmitting microwave reflector for a substrate processing chamber, the method comprising electroforming a metallic frame surrounding a micromesh screen such that the micromesh screen comprises an open area of greater than 80% of the total area.

10. A method according to claim 9 comprising electroforming the frame surrounding the micromesh screen by:
(a) cleaning a surface of a preform;
(b) applying a layer of photoresist on a surface of the preform;
(c) placing a photomask having a micromesh pattern over the photoresist layer;
(d) exposing the photoresist layer to light that passes through the photomask to imprint an image of the micromesh pattern of the photomask on the photoresist layer;
(e) developing the exposed photoresist to form a pattern of raised resist features;
(f) depositing material from an electrolytic solution onto the recessed regions between the resist features to form interconnected solid segments that define a micromesh screen; and
(g) stripping the frame and micromesh screen off the preform.

11. A method according to claim 10 wherein (f) comprises:
(i) immersing the surface of the preform in a metal-containing electroforming solution;
(ii) passing an electrical current through the solution.

12. A method according to claim 10 comprising electroforming the metallic frame to have at least one of the following characteristics:
(i) a width of at least about 20 mm;
(ii) a thickness of from about 20 microns to about 100 microns;
(iii) a plurality of openings that each comprise an area of from about 1 mm² to about 5 mm².

13. An ultraviolet-transmitting microwave reflector for a substrate processing chamber, the reflector comprising:
(a) an ultraviolet transparent plate; and
(b) a micromesh screen extending across the ultraviolet transparent plate.

14. A reflector according to claim 13 wherein the micromesh screen comprises at least one electroformed layer.

15. A reflector according to claim 13 wherein the micromesh screen comprises at least one of the following:
(i) an open area of greater than 80% of the total area; and
(ii) a plurality of openings that each have an area of least 1 mm².

16. A reflector according to claim 17 wherein the ultraviolet transparent plate comprises a quartz plate.

17. A reflector according to claim 20 wherein the quartz plate comprises a thickness of from about ¼″ to about 2″.

18. A method of fabricating an ultraviolet-transmitting microwave reflector for a substrate processing chamber, the method comprising:
(a) forming ultraviolet transparent plate; and
(b) electroforming a micromesh screen onto the ultraviolet transparent plate, wherein the micromesh screen comprises an open area of greater than 80% of the total area.

19. A method according to claim 18 electroforming one or more patterned layers to form the micromesh screen.

20. A method according to claim 18 comprising electroforming the micromesh screen by:
(a) cleaning a surface of a preform;
(b) applying a layer of photoresist on a surface of the preform;
(c) placing a photomask having a micromesh pattern over the photoresist layer;
(d) exposing the photoresist layer to light that passes through the photomask to imprint an image of the micromesh pattern of the photomask on the photoresist layer;
(e) developing the exposed photoresist to form a pattern of raised resist features; and
(f) depositing material from an electrolytic solution onto the recessed regions between the resist features to form interconnected solid segments that define a micromesh screen.

21. An ultraviolet-transmitting microwave reflector for a substrate processing chamber, the reflector comprising:
(a) a micromesh screen comprising a grid of solid segments; and
(b) a coating media covering the solid segments.

22. A reflector according to claim 21 wherein the coating media comprises an ultraviolet-transmitting media.

23. A reflector according to claim 21 wherein coating media comprises a polymer.

24. A reflector according to claim 21 wherein the micromesh screen comprising electroformed layers.

25. A reflector according to claim 21 wherein the coating media comprises a thickness of from about 2 microns to about 10 microns.

26. A method of fabricating an ultraviolet-transmitting microwave reflector for a substrate processing chamber, the method comprising:
(a) electroforming a micromesh screen comprising a grid of solid segments; and
(b) coating the solid segments with a coating media.

27. A method according to claim 26 comprising coating the solid segments with an ultraviolet-transmitting media.

28. A method according to claim 27 comprising coating the solid segments with a polymer.

29. A method according to claim 26 comprising electroforming the micromesh screen by:
(a) cleaning a surface of a preform;
(b) applying a layer of photoresist on a surface of the preform;
(c) placing a photomask having a micromesh pattern over the photoresist layer;
(d) exposing the photoresist layer to light that passes through the photomask to imprint an image of the micromesh pattern of the photomask on the photoresist layer;
(e) developing the exposed photoresist to form a pattern of raised resist features;
(f) depositing material from an electrolytic solution onto the recessed regions between the resist features to form interconnected solid segments that define a micromesh screen; and
(g) stripping the micromesh screen off the preform.

30. A method according to claim 29 wherein (f) comprises:
(i) immersing the surface of the preform in a metal-containing electroforming solution; and
(ii) passing an electrical current through the solution.
